(19) United States
(12) Patent Application Publication
(10) Pub. No.: US 2007/0153824 A1
(43) Pub. Date: Jul. 5, 2007

(54) Uniform corporate client (UCC) usage model

(76) Inventors: Hong Wong, Portland, OR (US); Truong Phan, Hillsboro, OR (US); Wah Yiu Kwong, Beaverton, OR (US); Murali Veeramoney, Beaverton, OR (US); Hue Lam, Portland, OR (US); Steven Asbjornsen, Tualatin, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/323,496

(22) Filed: Dec. 31, 2005

(51) Int. Cl. H04J 3/22

(52) U.S. Cl. 370/465; 370/401

(57) ABSTRACT

A system board is to be designed as a standardized system board so that it can be used either in a mobile computer system or in a non-mobile computer system. In some embodiments, the system board may be fundamentally designed for the mobile computer system. Some reconfiguration may be performed to use the system board in the non-mobile computer system.

### FIELD OF INVENTION

The present invention relates generally to the field of computer design, and more specifically, to techniques for configuring computer systems.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers.

Computer systems may generally be classified as either mobile computer systems or desktop computer systems. Computer manufacturers such as, for example, Dell Computers of Austin, Tex. offer an array of mobile computer systems and desktop computer systems. Each computer system may be designed for a different price point or for a different type of user. For example, a power user in a corporate environment may want a desktop computer system with a fast processor, large disk storage, etc. A user who often travels may want a light laptop computer system that includes a battery and a wireless communication adapter, etc. For a large corporation, the tasks of deploying and supporting a large number of desktop and portable computer systems can be daunting.

Traditionally, mobile computer systems may be equipped with electronic components that are sensitive to power consumption and heat generation. As such, these electronic components may include features that are a subset of their counterparts used in the desktop computer systems. For example, a processor configured for a mobile computer system may run at a lower speed (e.g., measured in megahertz or MHz) than a processor configured for a desktop computer system. Recent developments begin to focus less on the speed of the individual electronic components and more on the overall speed of a group of electronic components such as those on a system board. Computer manufacturers may be able to take advantage of these developments to deliver further benefits to the consumers.

### BRIEF DESCRIPTION OF THE DRAWINGS

The present invention is illustrated by way of example and not limitation in the accompanying figures in which like references indicate similar elements and in which:

FIG. 1 is a block diagram illustrating an example of a computer system, in accordance with some embodiments.

FIG. 2 illustrates an example of a system board, in accordance with some embodiments.

FIG. 3 illustrates an example of a system board, in accordance with some embodiments.

FIG. 4 illustrates an example of a non-mobile computer system, in accordance with some embodiments.

FIG. 5 illustrates an example of a non-mobile computer system using a system board with a secondary display support, in accordance with some embodiments.

FIG. 6 is a block diagram illustrating an example of a process that may be used, in accordance with some embodiment.

FIG. 7 is a block diagram illustrating another example of a process that may be used, in accordance with some embodiments.

### DETAILED DESCRIPTION

For some embodiments, a system board may be designed primarily to be used in a mobile computer system. The system board may be reconfigured to be used in a non-mobile computer system. In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

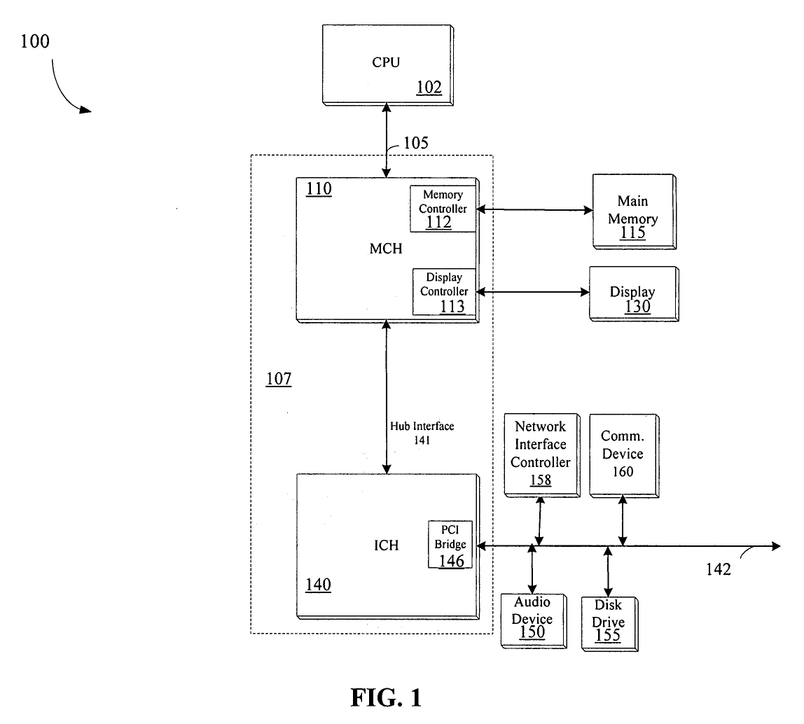

FIG. 1 is a block diagram illustrating an example of a computer system. Computer system 100 may be a mobile computer system. Computer system 100 may include a central processing unit (CPU) 102 and may receive its power from an electrical outlet, a battery (not shown), or any other power sources. The CPU 102 and chipset 107 may be coupled to bus 105. The chipset 107 may include a memory control hub (MCH) 110. The MCH 110 may include a memory controller 112 that is coupled to memory 115. The memory 115 may store data and sequences of instructions that are executed by the CPU 102 or any other processing devices included in the computer system 100. The MCH 110 may include a display controller 113. Display 130 may be coupled to the display controller 113. The chipset 107 may also include an input/output control hub (ICH) 140. The ICH 140 may be coupled with the MCH 110 via a hub interface 141. The ICH 140 may provide an interface to peripheral devices within the computer system 100. The ICH 140 may include PCI bridge 146 that provides an interface to PCI bus 142. The PCI bridge 146 may provide a data path between the CPU 102 and the peripheral devices. In this example, an audio device 150, a disk drive 155, communication device 160, and network interface controller 158 may be connected to the PCI bus 142. The disk drive 155 may include a storage media to store data and sequences of instructions that are executed by the CPU 102 or any other processing devices included in the computer system 100.

System Board

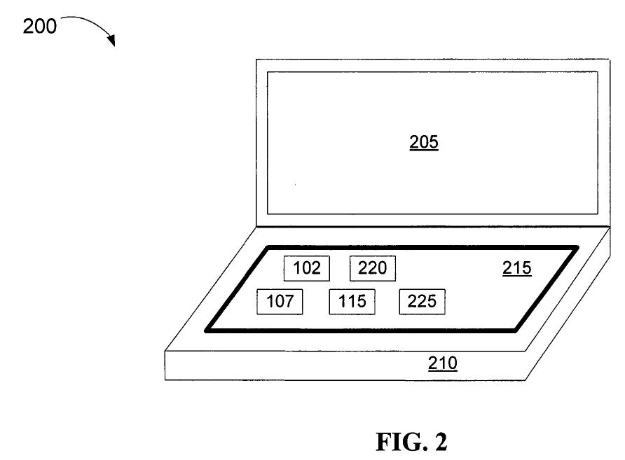

Most of the electronic components described above may be included in a system board (not shown). For example, the system board may include the CPU 102, the chipset 107, memory 115, display controller 113, etc. The system board may also be referred to as a mother board, a base board, a main circuit board, etc. FIG. 2 illustrates an example of a system board, in accordance with some embodiments. Computer system 200 may include a base unit 210 coupled to a display unit 205. The display unit 205 may include a display screen which may be a liquid crystal display (LCD) or a display implemented using various other display technologies. The base unit 210 may include a keyboard (not shown). In this example, the base unit 210 and the display unit 205 may be designed to operate together in a clam-shell form factor typically seen in laptop or mobile computer systems.

The base unit 210 may serve as an enclosure for system board 215. The system board 215 may include standard electronic components (e.g., processor 102, chipset 107, and memory 115) that may typically be found on any system board (e.g., system board for mobile computer system, system board for desktop computer system, etc.). When a system board is designed for a mobile computer system, it may include electronic components (e.g., battery pack 220) that may be specifically used in a mobile computer system. When a system board is designed for a non-mobile computer system (e.g., a desktop computer system, a server, a media center, etc.), the system board may have a different size and may include other electronic components that are applicable for a non-mobile computer system. Since wireless communication is becoming more popular, it may be possible to have a wireless communication module (e.g., wireless communication module 225) on a system board for both mobile and non-mobile computer systems.

Standardized System Board

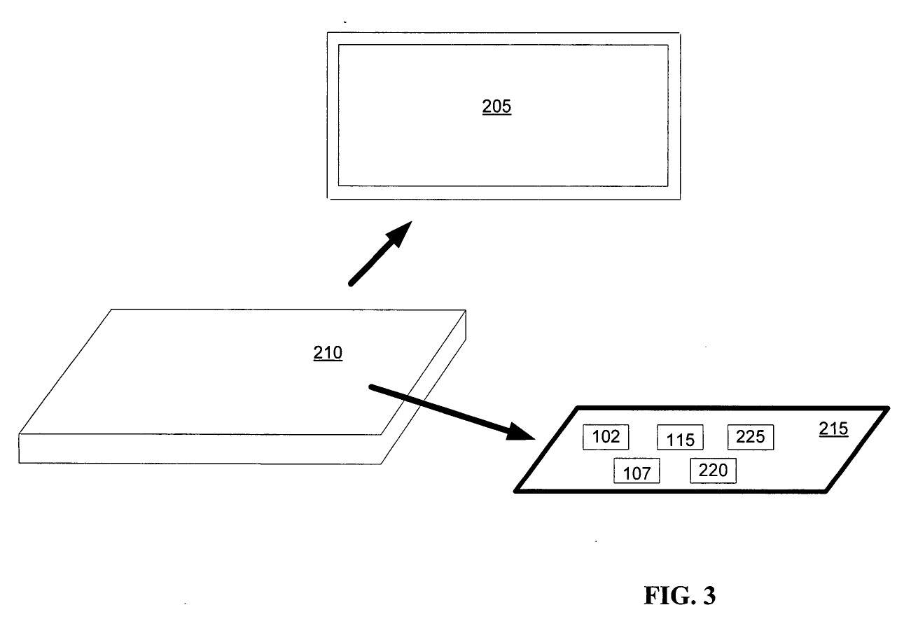

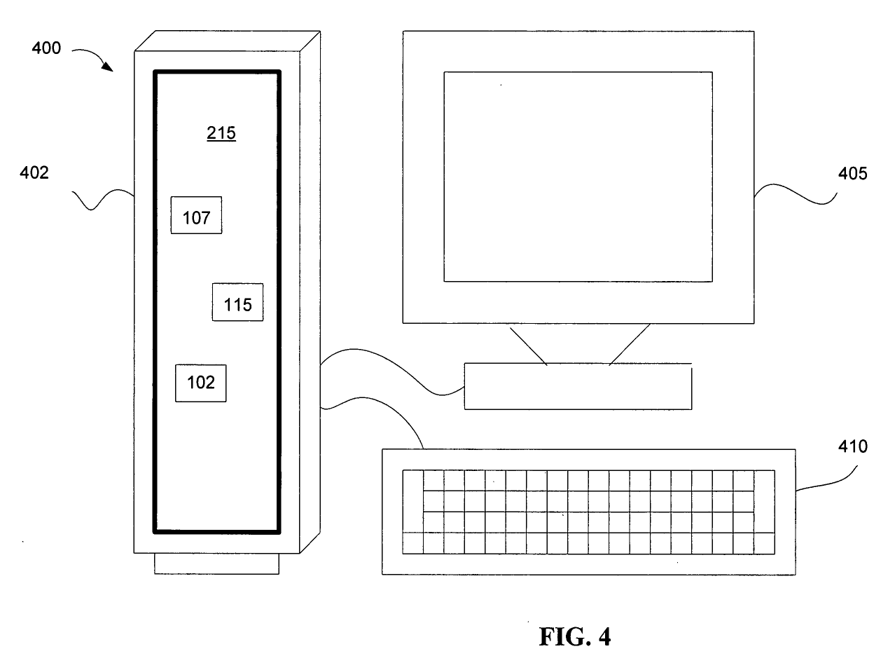

FIG. 3 illustrates an example of a system board, in accordance with some embodiments. As illustrated, the computer system 200 in FIG. 2 may be de-assembled by detaching the display unit 205 and by removing the system board 215 from the base unit 210. It is envisioned that the system board 215 may be installed into an enclosure designed for a non-mobile computer system. FIG. 4 illustrates an example of a non-mobile computer system, in accordance with some embodiments. Continuing with the example in FIG. 3, computer system 400 may be built by adding an external keyboard 410, an external display 405, and a non-mobile system unit 402. The computer system 400 may also include some other components. The system unit 402 may serve as an enclosure for a system board. In this example, to illustrate the benefit of having a standardized system board, the system board 215 used with the computer system 200 (illustrated in FIG. 2) may also be used with the computer system 400.

For some embodiments, a standardized system board may be designed to include electronic components that are common for both a mobile and a non-mobile computer system. For example, the common electronic components may include an audio port, headphone and microphone connectors, universal serial bus (USB) connector, etc. The standardized system board may then be reconfigured to be used for a mobile or a non-mobile computer system. For some embodiments, reconfiguration may include adding to the standardized system board some electronic components that are applicable in a mobile computer system. For example, a battery pack may be added to the standardized system board.

For some other embodiments, reconfiguration may include adding some components that are more applicable in a non-mobile computer system. For example, an advanced graphics adapter may be added to the standardized system board. It is envisioned that in order to use the standardized system board, the enclosure of a mobile computer system and the enclosure of a non-mobile computer system are sufficiently large enough to accommodate the footprint of the standardized system board. These enclosures may also need to have similar fittings to allow the standardized system board to be securely fastened to the enclosures. Using a standardized system board may be advantageous for computer manufacturers because it may reduce system design, validation and qualification cost.

Mobile-specific Standardized System Board

Mobile computing is becoming more popular, and the number of mobile computers purchased by consumers is almost as many as the number of non-mobile computers. Furthermore, the electronic components used in a mobile computer system are becoming more efficient (e.g., less heat generation, etc.) narrowing the gap from their counterparts in non-mobile computer systems. For some embodiments, the standardized system board may be fundamentally designed for a mobile computer system. One advantage of this technique is that the mobile specific standardized system board may be used to build a mobile computer system with minimal or no reconfiguration. For example, the mobile specific standardized system board may already include a battery pack. The mobile specific standardized system board may also include a wireless communication module. When a non-mobile computer system is to be built, the mobile specific standardized system board may also be used. Some reconfiguration may be needed to adapt the mobile specific standardized system board to the non-mobile computer system. As an example, this may include removing the battery pack. As another example, this may include adding an advanced graphics adapter.

For some embodiments, a standardized set of software may be associated with a standardized system board. For example, an image of a standardized set of software may be used regardless whether it is to be installed on a mobile or a non-mobile computer system.

Standardized System Board with Secondary Display Support

A standardized system board may include logic to support a primary display. For some embodiments, the standardized system board may also include logic to support a secondary display. The secondary display may be supported by the processor (e.g., the processor 102 illustrated in FIGS. 2-4) on the standardized system board. For some embodiments, the secondary display may be supported by a dedicated controller. Using a standardized system board with support for the secondary display may enable a mobile computer system to offer features that may allow continuous access to information (e.g., calendar, emails, etc.) when the main processor (e.g., processor 102) is placed in a low power mode.

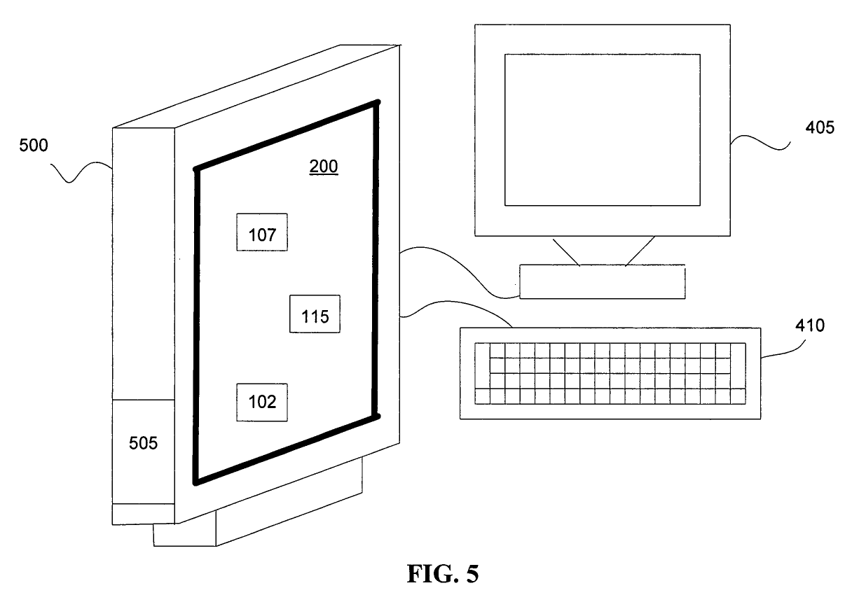

FIG. 5 illustrates an example of a non-mobile computer system using a system board with a secondary display support, in accordance with some embodiments. Computer system 500 includes a standardized system board 504 that supports a secondary display. In this example, the computer system 500 includes an external display 405 and a secondary display 505. The secondary display 505 may be positioned anywhere on the external surface or skin of the enclosure 502. The standardized system board 504 and its secondary display support may enable the non-mobile computer system 500 to offer features such as video conferencing, voice over Internet Protocol (VoIP), caller identification, music title, program guide, television channel, etc. The secondary display 505 may be on while the external display 405 may be off to conserve power. This may be advantageous when the availability of the power supply is intermittent or unreliable. For example, when used in a rural environment (e.g., in third world countries) where reliance on direct current (DC) power source is more frequent than on alternating current (AC) power source, the secondary display 505 may provide an efficient low power approach to continue using certain features of the non-mobile computer system. The DC power source in these situations may be an un-interruptible power supply (UPS). The standardized system board may include features to allow adapting more battery packs to support the UPS feature.

Process

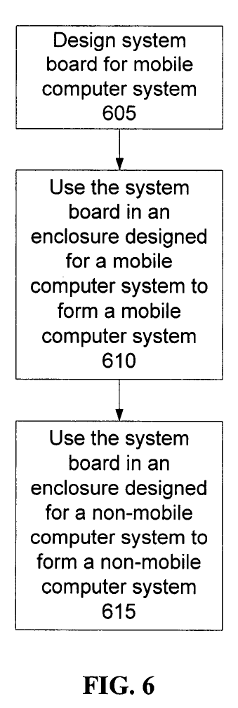

FIG. 6 is a block diagram illustrating an example of a process that may be used, in accordance with some embodiment. The process assumes that the enclosure of a mobile computer system and the enclosure of a non-mobile computer system have been designed to accept a standardized system board. At block 605, the standardized system board is designed. It may have a particular size, shape and may include a certain number of electronic components to make it standardized for both mobile and non-mobile computer systems. At block 610, the standardized system board may be adapted into an enclosure for a mobile computer system to build a mobile computer system. Alternatively, when a non-mobile computer system is desired, the standardized system board may be adapted into another enclosure to build a non-mobile computer system, as shown in block 615.

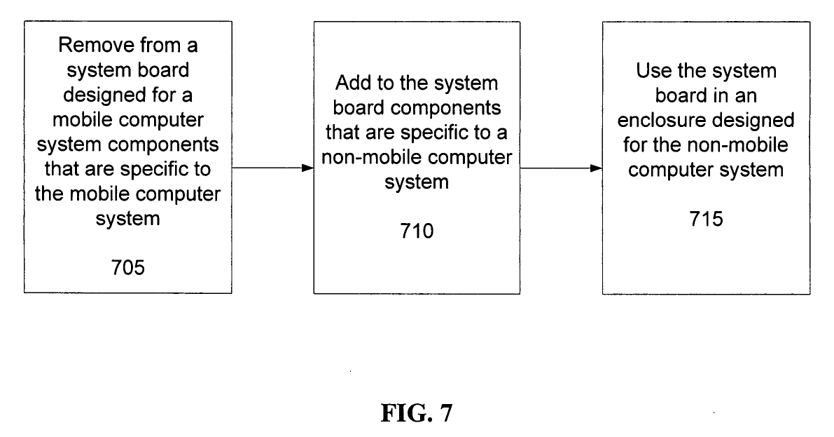

FIG. 7 is a block diagram illustrating another example of a process that may be used, in accordance with some embodiments. This process assumes that a standardized system board has been fundamentally designed for a mobile computer system. At block 705, the standardized system board may need to be reconfigured to be used in an enclosure for a non-mobile computer system. This may involve removing electronic components that are specific to a mobile computer system. At block 710, electronic components that are specific to a non-mobile computer system may be added to the standardized system board. At block 715, the reconfigured system board may then be adapted into the enclosure for a non-mobile computer system.

Although some embodiments of the present invention have been described with reference to specific exemplary embodiments, it will be evident that various modifications and changes may be made to these embodiments without departing from the broader spirit and scope of the invention as set forth in the claims. For example, although some embodiments have been described as being associated with a computer system, the color cylinder may also be used in various other applications (e.g., television systems, etc.). Accordingly, the specification and drawings are to be regarded in an illustrative rather than a restrictive sense.

What is claimed is:

1. A method, comprising:
providing a standardized system board;
using the standardized system board for a mobile computer system; and
alternatively, using the standardized system board for a non-mobile computer system.

2. The method of claim 1, wherein the standardized system board is designed fundamentally to be used for the mobile computer system

3. The method of claim 2, wherein using the standardized system board for the non-mobile computer system comprises:
reconfiguring the standardized system board before it is used for the non-mobile computer system.

4. The method of claim 3, wherein reconfiguring comprises:
removing mobile specific electronic components from the standardized system board.

5. The method of claim 3, wherein reconfiguring comprises:
adding non-mobile specific electronic components to the standardized system board.

6. The method of claim 5, wherein the standardized system board includes support for a first display and a secondary display.

7. The method of claim 6, wherein the standardized system board includes support for un-interruptible power supply (UPS).

8. The method of claim 5, wherein the standardized system board is associated with a standardized set of software application applicable for both the mobile computer system and the non-mobile computer system.

9. A system, comprising:
a system board that includes a processor, a memory, and a bus coupled to the processor and the memory, and at least one mobile specific component coupled to the bus to enable the system board to operate when the system is a mobile system, wherein the system board is configurable to be used when the system is a non-mobile system.

10. The system of claim 9, wherein the system board is configurable to be used when the system is a non-mobile system by removing the mobile specific component.

11. The system of claim 10, wherein the system board is configurable to be used when the system is a non-mobile system by adding one or more non-mobile specific components.

12. The system of claim 11, wherein the system board further includes electronic components to support a primary display and a secondary display.

13. The system of claim 12, wherein the secondary display is to be used as en alternate display from the primary display when power supply is limited.

14. The system of claim 12, wherein the system board includes electronic components to support un-interruptible power supply (UPS).

15. An apparatus, comprising:
a processor; and
a system board having multiple electronic components including the processor, the system board configured to be enclosed in a first housing or in a second housing, the first housing used when the computer system is configured as a mobile computer system, the second housing used when the computer system is configured as a non-mobile computer system

16. The apparatus of claim 15, wherein the system board is to include support for a primary display, a secondary display, and un-interruptible power supply (UPS).

17. The apparatus of claim 15, wherein the system board is to be associated with a software image applicable for the mobile computer system and for the non-mobile computer system.

18. The apparatus of claim 15, wherein the system board is configured to be enclosed in the first housing or in the second housing without size or shape modification.

19. The system of claim 15, wherein when one of the multiple electronic components on the system board is mobile specific, the mobile specific component is removed before the system board is enclosed in the second housing.

20. The system of claim 15, wherein when the system board is to be enclosed in the second housing, one or more non-mobile specific components is added to the system board.
